(19) United States
(12) Patent Application Publication
(10) Pub. No.: US 2016/0355043 A1
(43) Pub. Date: Dec. 8, 2016

(54) SYSTEM AND METHOD FOR PRODUCTION AND VERIFICATION OF COUNTERFEIT-PROTECTED BANKNOTES

(71) Applicant: YXCORP14 INC., Atascadero, CA (US)

(72) Inventor: Cornel K. POKORNY, Atascadero, CA (US)

(21) Appl. No.: 14/730,153

(22) Filed: Jun. 3, 2015

(51) Int. Cl. B42D 25/30; B42D 25/40

(52) U.S. Cl. CPC B42D 25/30; B42D 25/40; B42D 2033/28; B42D 2035/02

(57) ABSTRACT

A unique method for producing one or more counterfeit-protected banknotes on a banknote paper source having multiple inclusions of irreproducible-patterns (IRPAT) and digital patterns is provided for. A data matrix is generated in relation to certain characteristics such as digital security techniques and banknote denomination, and the data matrix and IRPAT are associatively arranged on banknote paper source for authenticating the banknote as currency. A unique method for verifying a banknote produced by the method of the invention is also provided.

### FIELD OF THE INVENTION

The present disclosure relates to banknotes such as currency, and more particularly to the production and verification of anti-counterfeit banknotes.

### BACKGROUND

Ensuring the authenticity of currency, such as banknotes, remains an area of interest. Some existing systems which attempt to provide some form of authenticity assurances have various shortcomings, drawbacks and disadvantages relative to certain applications. For example, in some methods, to provide for counterfeit-proof currency, complex combinations of chemicals additives requiring various lighting and viewing modes are set forth which are not readily desirous, in part due to their complexity and costs. Other efforts have included anti-counterfeiting systems such as holograms, multi-colored bills, embedded strip devices, pearl ink, latent images, microprinting, watermarks and color-affected inks. In some venues, other anti-counterfeiting currency methods have sought to add design features that may attempt to disable photocopiers or add intrinsic fluorescence.

However, for many of these methods, there are counter approaches that thwart these methods. In view of current trends involving areas such as 3-D printing and other reproduction technologies, further methods are needed to overcome advances in copying technologies, particular in the area of currency. Accordingly, there remains a need for further contributions in this area of technology.

### SUMMARY

Embodiments of the present application include a system and method to add to a banknote document an irreproducible pattern (i.e., IRPAT) in a unique manner in accordance with the present invention in which a corresponding digital pattern (i.e., DPAT) is digitally signed onto the banknote document. Using the produced banknotes of the invention, machines that would check for the validity of the banknote would determine the note to be valid as the DPAT would be identified as valid and the DPAT would match the IRPAT of the note on the same document.

In one refinement, a method for producing one or more counterfeit-protected banknotes on a banknote paper source having multiple inclusions of irreproducible-patterns (IRPAT), comprising: providing for a cutout of a fixed predetermined size of the IRPAT, generating a message in relation to at least one digital signature security technique, transforming the generated message into a data matrix, providing the data matrix and an IRPAT portion in an associated relation for printing on the banknote paper source, and printing a final banknote image over the banknote paper source having the data matrix and IRPAT portion in associated relation, is provided for.

In another refinement, a method further includes individually or in combination i) scanning the IRPAT cutout using a scanner device to generate a plurality of patterned cells, ii) storing the plurality of patterned cells for access, iii) having the scan consist of a binary number, iv) at least one digital signature security technique including RSA, DSA and CFS, and v) the data matrix and an IRPAT portion are dimensionally associated with one another to form a pattern suitable for printing on the banknote paper source prior to printing the final banknote image.

In another refinement, a method for verifying one or more counterfeit-protected banknotes printed on a banknote paper source having multiple inclusions of irreproducible-patterns (IRPAT), comprising: inserting a subject banknote into a checking device, determining whether the subject banknote has inclusions embedded in the irreproducible pattern (IRPAT) banknote paper, reading a data matrix and denomination of the subject banknote and extracting a message from the read data matrix in relation to at least one digital signature security technique, and determining the authenticity of the subject banknote, is provided for.

In a further refinement, an authentic counterfeit-protected banknote having one or more irreproducible patterns (IRPAT) and one or more digital patterns, geometrically associated with one another and printed on a banknote paper source, wherein the banknote paper source has one or more synthetic inclusions, the digital patterns comprise one or more data matrixes associated with at least the denomination of the banknote, and the combination of the IRPAT and digital patterns are detectable by a checking device, is provided for.

### BRIEF DESCRIPTION OF THE DRAWINGS

The description herein makes reference to the accompanying drawings wherein like reference numerals refer to like parts throughout the several views, and wherein:

FIG. 1 sets forth four examples of cutouts from IRPAT sources in accordance with one aspect of the invention;

FIG. 2 sets forth a cutout of an IRPAT paper having metal inclusions wherein the cutout is of a fixed size (i.e., dimension) and scans of the cutout for one or more aspects of the invention;

FIG. 3 depicts a production process flowchart for the creation of an individual banknote or one or more banknotes for the invention;

FIG. 4 sets forth the process continuing from the step of FIG. 3, transforming m in accordance with an embodiment of the invention;

FIG. 5 depicts a verification process flowchart for the verifying of an individual banknote or one or more banknotes produced under the present invention;

### DETAILED DESCRIPTION

The present disclosure relates to banknotes such as currency, and more particularly to the production and verification of anti-counterfeit banknotes. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

For purposes of promoting an understanding of the principles of the production and verification processes for counterfeit-protected banknotes, reference will now be made to the examples illustrated in the drawings, and specific language will be used to describe the same. It will nonetheless be understood that no limitation of the scope of the invention is intended by the illustration and description of certain examples of the invention. In addition, any alterations and/or modifications of the illustrated and/or described embodiment(s) are contemplated as being within the scope of the present invention. Further, any other applications of the principles of the invention, as illustrated and/or described herein, as would normally occur to one skilled in the art to which the invention pertains, are contemplated as being within the scope of the present invention.

In the production of process flowchart for the creation of one or more individual banknotes that are counterfeit-protected (or have anti-counterfeiting characteristics), the process includes certain key aspects which are further described below. Further, there are set forth a protection process for producing the counterfeit-protected banknotes and a verification process for checking the counterfeit-protected banknotes.

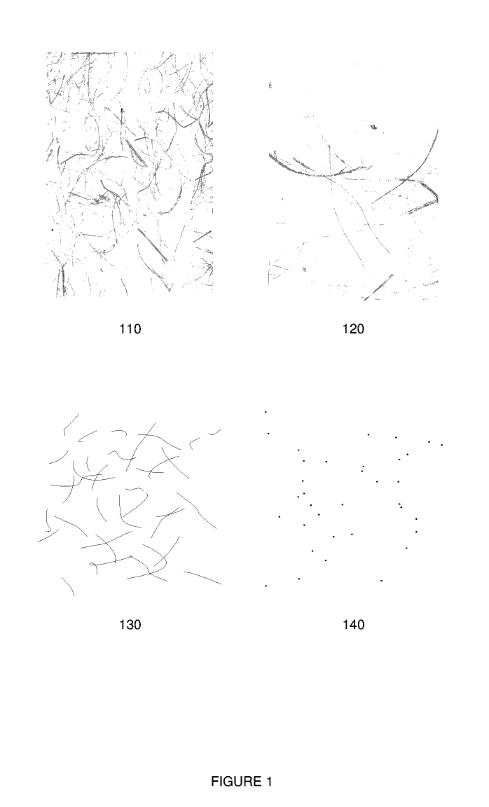

FIG. 1 sets forth an irreproducible pattern referred to as an IRPAT. As used herein, an IRPAT is an analog pattern that is the result of randomness in the production process of the present invention and therefore cannot be reproduced.

From FIG. 1, two examples of paper having natural fiber inclusions are set forth. The term paper is intended to include mediums for which banknotes and currency may be used but is not necessarily limited to a pulp or wood based substance.

Two examples of paper are set forth at 110 and 120 where each paper sample is different from the other and demonstrates that no two cutouts of paper having inclusions would ever be duplicates of one another. Samples such as those of 110 and 120 would be examples of IRPATs. By further example, an IRPAT may be any medium having inclusions in which when a cutout (i.e., a fixed portion) of the medium is segregated from the source, said cutout would not match any other cutout from the same or similar source; in other words, an IRPAT cannot provide any two cutouts that would be identical or alike with respect to the inclusions therein.

Further, FIG. 1 sets forth two examples of cutouts from IRPAT sources. At 130 the random inclusions consist of thin metal threads, and at 140 the cutout example sets forth inclusions of small metal sphericles. As will be appreciated by those skilled in the art, since randomness is essentially involved in the production process, each IRPAT can be produced only once in a unique way and result, and cannot be reproduced to match the initial result.

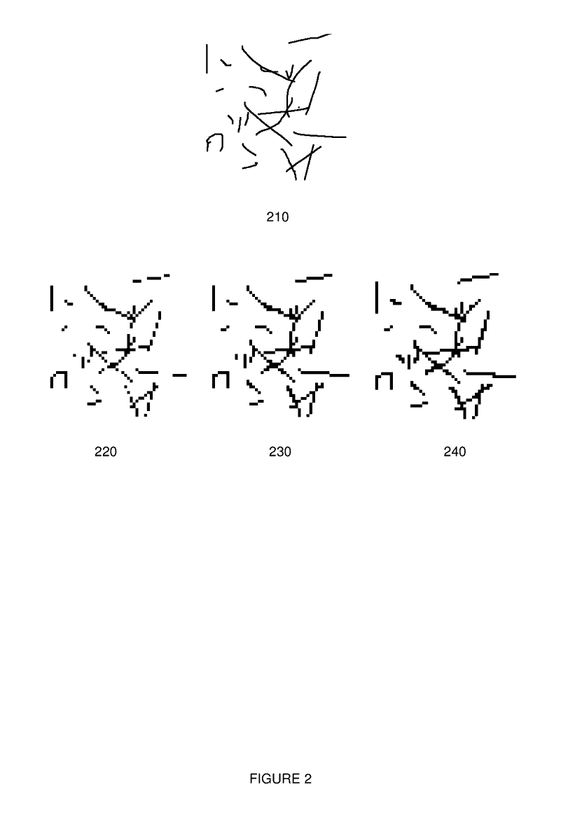

By way of example, FIG. 2 sets forth a cutout and scans of the cutout of an IRPAT paper having metal inclusions wherein the cutout is of a fixed size. The cutout is at 210.

At 220, 230 and 240 are scans of the cutout. A scan of the above IRPAT cutout is a result of the scanning of the cutout made with a scanner, that is then preferably stored digitally. A scan may be understood in one or more aspects, in certain preferred embodiments, to be similar to that of a rectangular raster laid over the IRPAT. The raster may be of any degree of fineness desired. In one or more preferred embodiments, a raster of 50×50 is desired. Any cell of the raster that is crossed by a metal thread to or above a certain degree is considered as a 1, whereas every other is therefore considered as a 0. The 50×50 cells of the raster correspond to a 2500 bit long binary number which corresponds to an approximately 806 digits long decimal number.

Scan 220, 230 and 240 set forth three examples of scans of the referenced IRPAT in 50×50 resolution but each has differing scanning sensitivities. For instance scan 220 has a lower or weaker sensitivity of scan than does 230; scan 230 has a weaker sensitivity than scan 240. In operation, the present invention uses a predetermined scanning sensitivity most suitable for the desired outcome of the process.

In the present invention, in one or more preferred embodiments, the papers utilized for counterfeit-protected banknotes include synthetic inclusions as opposed to natural inclusions which may be utilized as IRPATs for the present invention. Examples of synthetic inclusions may also include metals (such as gold, silver, steel, aluminum, tungsten, copper and alloys thereof) and may be of varying length, width and other geometrical characteristics. For instance, such metal inclusions may have long shafts or be spherical in shape versus rod like, as a few examples not limited by the present invention, each of which would block ultraviolet (UV) light and thereby form an IRPAT with respect to the inclusions.

Protection Process—Providing for the Counterfeit-Protected Banknotes

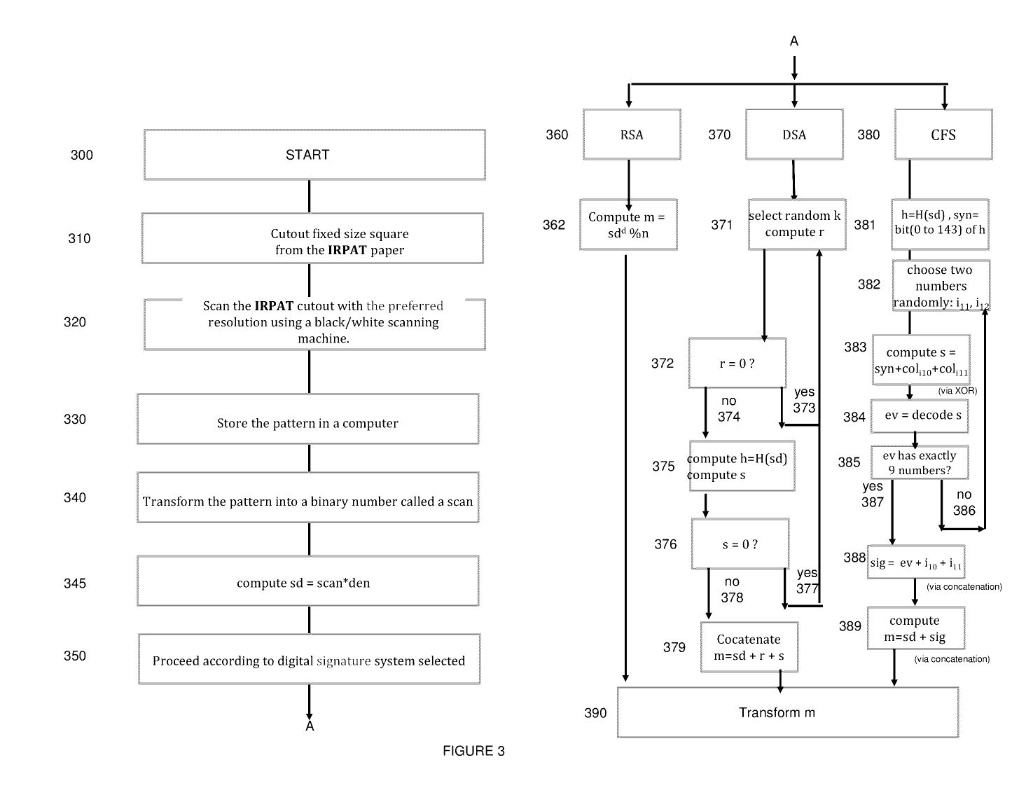

FIG. 3 depicts a production process flowchart for the creation of an individual banknote or one or more banknotes. As used herein, a banknote is intended to include any medium used for currency or that which may yield a value, whether a formal currency note or otherwise. From FIG. 3, the production process begins at 300. Once the process is initiated, a cutout of a fixed size, preferably but not restricted to a square configuration, is obtained from the IRPAT paper source, at 310. In a preferred embodiment, the fixed size is preferably 6 cm×6 cm. The cutout of 310 is similar to that depicted in FIG. 2 at 210 by example.

After the cutout is obtained at 310, the cutout is scanned using a scanner, at 320. In a preferred embodiment, the scanning resolution is 50×50, where a black and white scanning device is also preferably utilized. The scanned cutout results in a pattern having a predetermined resolution, based on the scanning resolution of 310, at 320. In a preferred embodiment the scanned pattern at 320 is 50×50 of black or white cells. The scanned pattern at 320 is similarly depicted as that in FIG. 2 at 220 though many variations are possible.

After the cutout is scanned, the scanned pattern is stored in a data storage location, at 330. In a preferred embodiment the data storage location may be a computer, a storage medium having a digital storage capability, a hard drive, thumb drive, or similar medium or device capable of storing an electronic file.

After the cutout pattern is stored at 330, the stored cutout pattern file is transformed to a binary number defined as a ‘scan’ herein, preferably being a binary number having a bit length of 2500, at 340.

At 345, the number scan is multiplied with the intended denomination of the banknote, den, resulting in a binary number defined as ‘sd’ herein.

Following the computation of the binary number ‘sd’ at 345, the process proceeds to producing a digital signature at 350 in relation to one of at least three digital signature methods. Preferably, but not exclusively, one of three digital signature methods is undertaken by the process wherein a digital signature may include that of RSA, DSA or CFS.

RSA digital signature, as used herein, is inclusive of a public-key encryption technology development typically attributed to RSA Data Security and/or the creators being Rivest, Shamir and Adleman. The RSA algorithm is based on the difficulty of factoring the product of two large prime numbers. Based on this principle, the RSA encryption algorithm uses the product of two large prime numbers as the trap door for encryption. RSA is often referenced as the standard encryption method for important data, especially data that's transmitted over the Internet.

DSA digital signature, as used herein, is inclusive of that often referred to as the Digital Signature Algorithm (DSA). DSA is understood to be a Federal Information Processing Standard for digital signatures and was proposed by the National Institute of Standards and Technology (NIST) in August 1991 for use in their Digital Signature Standard (DSS).

CFS digital signature, as used herein, is a fundamentally new method of Digital Signature which uses encoding and decoding as the trapdoor function; it is believed to be quantum computer resistant.

A digital signature path is then selected at 350 based on whether the approach will be RSA (360), DSA (370) or CFS (380).

Signing with RSA

Where RSA is selected at 360, in a preferred embodiment, it is assumed that the process via a banknote producer, following FIPS 186-4, has prepared RSA encryption keys consisting of the 3 numbers (n, e, d), suitable for encrypting numbers of the length of the defined sd. Preferably the private key consists of the two numbers (n, d), the public key of the two numbers (n, e), and the term n is the same in private and public key. At 362, the RSA computation occurs by using the private key (n, d) to compute m=sd^{d} % n. At 390, the transform m is determined, where m has a bit length equal to n.

Signing with DSA

Where DSA is selected at 370, in a preferred embodiment, it is assumed that the process via a banknote producer, following FIPS 186-4, has prepared DSA keys with the required cryptographic strength, consisting of the numbers n, q, g, x, and y, where the public key is (n,q,g,y) and the private key is (n,q,g,x). Additionally it is preferred that an approved SHA-2 cryptographic hash function H is also selected. Preferably, in one or more embodiments, bit lengths for the components of the DSA keys are 3072 for n, and 256 for q (for security lifetime extending beyond 2030); further it is desired in one or more preferred embodiments that H have a digest bit length of 256 or more.

At 371, the DSA computation occurs where a random k is selected having a value greater than zero and less than q, wherein k shall be different in value for each banknote. Further at 371, the computation for r is also determined wherein r=(g^{k} % n) % q.

Following the computation of r at 371, if at 372 r has a value equal to zero, then the process proceeds to 373 and returns to the step at 371. However if r has a value other than zero, then the process proceeds along 374 to 375 and computes h, wherein h=H (sd) and H is the chosen hash function. Further at 375, s can be determined “wherein s=(k⁻¹(H(m)+x*r)) % q”.

Following the computation of s at 375, if at 376 s has a value equal to zero, then the process proceeds to 377 and returns to the step at 371. However if s has a value other than zero, then the process proceeds to 378 and computes for m at 379. At 379, m is determined as m=sd⊕r⊕s (for clarity, as used herein, ⊕ is intended to be concatenation).

At 390, the transform m is determined, based on the computation above at 379.

Signing with CFS

Where CFS is selected at 380, in a preferred embodiment, it is assumed that the process via a banknote producer, has prepared a CFS Public Key Signature system based on a binary Goppa code over a finite field GF(2^{m}), with a capacity to correct 9 errors, and has chosen an approved SHA-2 cryptographic hash function, H. For the invention, the number ‘m’ in GF(2^{m}) in a preferred embodiment may be defined as m=16 or more, for instance. Further, the Goppa code is preferably described as r(L, g). For the process, the set L are the support values, which herein may or may not be inclusive of all the numbers from the field GF(2^{m}), g is a polynomial of degree 9 with coefficients therefrom, both, L and g are preferably kept secret. From the values L and the polynomial g, a binary parity check matrix M consisting of 144 (=9*m) rows and 65536 (=2^{m} or less, if L is not inclusive of all numbers from the field GF(2^{m})) columns is computed. Further, for the CFS path, the CFS Public Key consists of the matrix M requiring about 1.2 Mbytes storage for m=16, more for higher values of m.

At 381, the CFS computation occurs where syn is assigned the first 144 bits of the hash value H(sd). At 382, two numbers, i₁₀ and iᵢᵢ, are chosen randomly from the support values L. At 383 computation for s is performed, wherein s=syn XORed with the i₁₀th column of M and XORed with i₁₁th column of M. At 384, the step of decoding s is performed as though s were the encoding of a message, the decoding result is assigned to ev. The decoding result is a set of usually less than 9 different numbers from the support values L. At 385, a determination of whether ev has exactly 9 numbers is set forth. If ev has exactly 9 numbers, the process continues along 387 to 388. If ev has fewer or more than 9 numbers, the process continues along 386 and returns to 382. In one or more preferred embodiments, the loop of 382 to 383, 384, 385, and 386 may repeat about 9! times before a decodable s is determined.

At 388, the 9 numbers of ev and the randomly chosen numbers i₁₀ and i₁₁ from step 382 are all concatenated into sig, whereupon sig has exactly 11 numbers.

At 389 the transform m is computed by concatenating sd and sig.

### Producing the Counterfeit-Protected Banknotes

At 410 begins the process of adding the digital signature to the banknote.

At 420, m is transformed into a data matrix d using ECC 200. ECC 200 is recognized as the newest version of Data Matrix and uses Reed-Solomon codes for error and erasure recovery. ECC 200 allows the full error free reconstruction of the entire encoded data even when the matrix has sustained 30% damage, assuming the matrix can still be accurately located by the reading device.

From the data matrix d resulting from the step of 420, a location step is performed at 430. The location step of 430 includes locating on the banknote paper the location of one banknote and to print the data matrix in ultraviolet (UV) light sensitive ink in the left half of the banknote, preferably in one or more embodiments in a 6×6 cm format. An exemplar of the result of step 430 is set forth at 435.

From the banknote of 435, a portion is cut out from the banknote paper. Preferably, the cutout portion is approximately equal in size to the IRPAT and then it is replaced with the IRPAT at 440. An exemplar of the result of step 440 is set forth at 445.

At 450, having already achieved the resulting design of 445, the step of printing the banknote design (inclusive of picture, denomination, ornamental scrolls, etc.) over the entire banknote on one or more sides is then performed at 450. An example of a banknote printed over the result of the step at 450 is set forth at 455. At 455, a result may or may not produce a visible data matrix and IRPAT depending on the process and the details of the banknote.

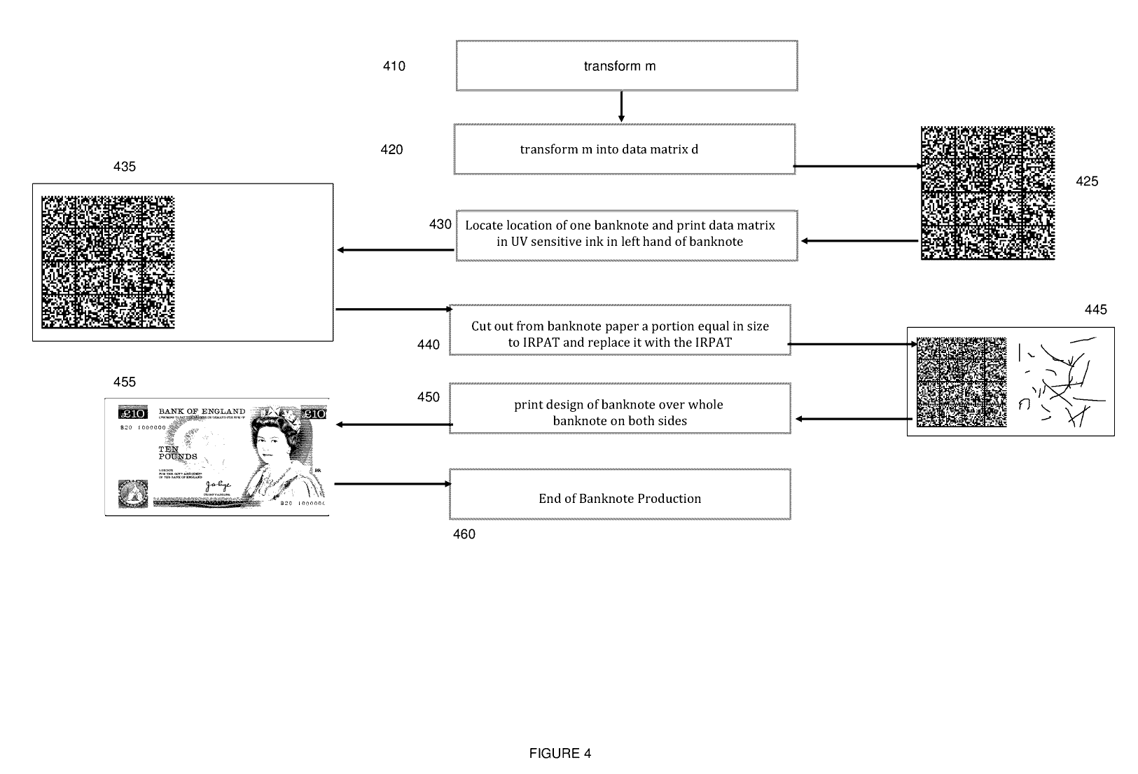

Following step 455, the production process for producing a banknote having anti-counterfeit characteristics is ended at 460. The process of FIG. 3 and FIG. 4 may be undertaken for one or more banknotes.

### Verification—Checking the Counterfeit-Protected Banknotes

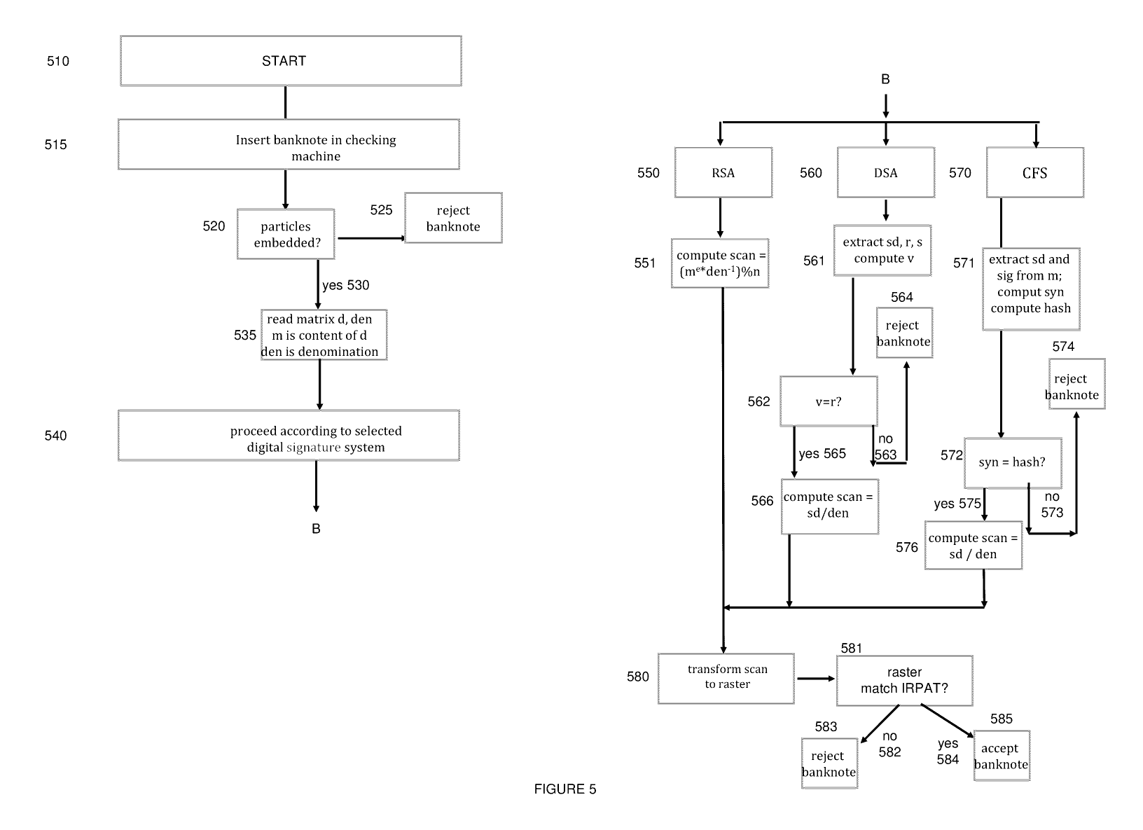

FIG. 5 depicts a verification process flowchart for the verifying of an individual banknote or one or more banknotes produced under the present invention. In verifying, it is common to utilize a commercially available checking machine (e.g., such as but not limited to Accu Banker) that are used widely for checking banknotes. These machines could be adapted or similar ones could be built that scan the IRPAT and the data matrix using UV light, and read the banknote denomination.

From FIG. 5, verifying the signature is set forth. The process is initiated at 510 by starting the checking or verification process. At 515, a banknote is inserted into a checking machine and a determination of whether IRPAT particles are embedded in the banknote or not is made at 520. Where no IRPAT particles are determined to be embedded but only ink spots are on the surface of the IRPAT material, the banknote is rejected at 525. Where the IRPAT particles are determined to be embedded in the banknote, the process continues at 530.

At 535, a reading of the data matrix ‘d’ and the denomination ‘den’ value is performed from the banknote, where m is extracted from the data matrix. The process then continues to 540 where a path is selected in accordance with a selected digital signature system being one or more of at least RSA, DSA or CFS, (550, 560, and 570, respectfully) as previously discussed.

Verification with RSA

As the process proceeds under an RSA verification pathway at 550, a computation is performed at 551, where scan is computed as (m^{e}*den⁻¹) % n. It will be appreciated by those skilled in the art that den⁻¹% n will always exists as den, is a small number (<10000, highest denomination of a banknote) and therefore guaranteed to have no common factor with n. The process then continues to 580 where the scan is transformed into a raster.

Verification with DSA

As the process proceeds under a DSA verification pathway at 560, computations are performed at 561. At 561, computations are performed to determine via extraction of the numbers sd, r, and s from m and the steps of computing h=H(sd), w=s⁻¹ %, q, u1=h*w % q, u2=r*w % q, and computing v=((g^{u1}*y^{u2}) % n) % q are performed. Based on the computed results of 561, a determination of whether v=r is performed at 562. If v does not equal r at 562, then the path continues along 563 and the banknote is rejected at 564. If v does equal r at 562, then the process continues along path 565 and further computations are undertaken at 566.

At 566, the computation of scan=sd/den is performed. The process then continues to 580 where the scan is transformed into a digital raster preferably of size 50×50 or similar.

Verification with CFS

As the process proceeds under a CFS verification pathway at 570, computations are performed at 571. At 571 the numbers sd and sig are extracted from m and ‘syn’ is computed as the XOR of those 11 columns of M, whose column numbers are in sig, and hash=H(sd) is computed. At 572, a determination of whether syn is equal to hash is performed. If syn does not equal hash at 572, then the path continues along 573 and the banknote is rejected at 574. If syn does equal hash at 572, then the process continues along path 575. At 576 scan is computed as scan=sd/den.

### Transform Scan to Raster, Compare to IRPAT

The process then continues to 580 where a transformation of the scan into a digital raster is undertaken, preferably at 50×50 or similar.

At 581, when comparing the digital raster to IRPAT, a scanning of the IRPAT by the checking machine at the same resolution as the digital raster is performed. Then a determination of whether the digital raster matches the scan of the IRPAT on an image processing level is undertaken. If the digital raster does not match IRPAT, then the path continues at 582 and the banknote is rejected at 583. If the digital raster does match, the path continues at 584 and the banknote is accepted at 585.

Deviations between the digital raster and the IRPAT up to a certain degree can be tolerated because different scannings of the IRPAT can lead to different scans. These deviations are inherent in the scanning process, since it is a transformation from analog to digital. The comparison is done on an image processing level.

In all cases, RSA and DSA and CFS, if the patterns match, the document is determined as being genuine and is authenticated under the process.

Further, with technological changes and improvements in the field, it is further envisioned that a verification machine could be adapted which scans the IRPAT and in this manner may determine whether the IRPAT consists of metal threads or sphericals embedded in the banknote paper; in this manner the scanning would also detect the sphericals and not only the presence of color dots from an inkjet printer occurring on the surface of a paper.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that a feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

In one refinement, a method for producing one or more counterfeit-protected banknotes on a banknote paper source having multiple inclusions of irreproducible-patterns (IRPAT), comprising: providing for a cutout of a fixed predetermined size of the IRPAT, scanning the IRPAT, transforming the scan into a binary number, digitally signing the binary number in relation to at least one digital signature security technique, generating a message from the binary number and the signature, transforming the generated message into a data matrix, providing the data matrix and an IRPAT portion in an associated relation for printing on the banknote paper source, and printing a final banknote image over the banknote paper source having the data matrix and IRPAT portion in associated relation, is provided for.

In another refinement, a method further include individually or in combination i) storing the plurality of patterned cells for access, ii) scanning the IRPAT cutout using a scanner device to generate a plurality of patterned cells, iii) having the scan consist of a binary number, iv) at least one digital signature security technique includes RSA, DSA and CFS, and v) the data matrix and an IRPAT portion are dimensionally associated with one another to form a pattern suitable for printing on the banknote paper source prior to printing the final banknote image.

In a further refinement, the final banknote image includes currency features suitable for public use such as picture, note denomination, ornamental depictions and one or more serial numbers.

In yet another refinement, in a preferred aspect, the plurality of cells is a pattern of black and white cells generated by using a scanner device to scan the IRPAT cutout.

In another refinement, a method for verifying one or more counterfeit-protected banknotes printed on a banknote paper source having multiple inclusions of irreproducible-patterns (IRPAT), comprising: inserting a subject banknote into a checking device, determining whether the subject banknote has inclusions embedded in the irreproducible pattern (IRPAT) banknote paper, reading a data matrix and denomination of the subject banknote and extracting a message from the read data matrix in relation to at least one digital signature security technique, and determining the authenticity of the subject banknote, is provided for.

In another refinement, a method further includes the checking device scanning the subject banknote for the IRPAT and the data matrix using a light source.

In a further refinement, an authentic counterfeit-protected banknote having one or more irreproducible patterns (IRPAT) and one or more digital patterns, geometrically associated with one another and printed on a banknote paper source, wherein the banknote paper source has one or more synthetic inclusions, the digital patterns comprise one or more data matrixes associated with at least the denomination of the banknote, and the combination of the IRPAT and digital patterns are detectable by a checking device, is provided for.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

What is claimed is:

1. A method for producing one or more counterfeit-protected banknotes on a banknote paper source having multiple inclusions of irreproducible-patterns (IRPAT), comprising:
providing for a cutout of a fixed predetermined dimension of the IRPAT,
generating a message in relation to at least one digital signature security technique,
transforming the generated message into a data matrix,
providing the data matrix and an IRPAT portion in an associated relation for printing on the banknote paper source,
and printing a final banknote image over the banknote paper source having the data matrix and IRPAT portion in associated relation.

2. The method of claim 1, further including the steps of generating a plurality of patterned cells and transforming the plurality of cells into a scan.

3. The method of claim 1, wherein the method further includes scanning the IRPAT cutout using a scanner device to generate a plurality of patterned cells.

4. The method of claim 3, wherein the scan consists of a binary number.

5. The method of claim 4, wherein at least one digital signature security technique includes RSA, DSA and CFS.

6. The method of claim 5, wherein the data matrix and an IRPAT portion are dimensionally associated with one another to form a pattern suitable for printing on the banknote paper source prior to printing the final banknote image.

7. The method of claim 1, wherein the final banknote image includes currency features suitable for public use such as picture, note denomination, ornamental depictions and one or more serial numbers.

8. The method of claim 1, wherein the plurality of cells is a pattern of black and white cells generated by using a scanner device to scan the IRPAT cutout.

9. The method of claim 8, wherein the resolution of the plurality of cells is determined by the resolution of the scanner device scanning the IRPAT cutout.

10. The method of claim 1, where the inclusions are synthetic.

11. The method of claim 10, wherein one or more inclusions are metallic.

12. The method of claim 1, wherein one or more inclusions are sphericles.

13. The method of claim 1, further including the step of producing one or more counterfeit-protected banknotes having an IRPAT and a digital pattern (d-pattern).

14. The method of claim 11, where the produced one or more counterfeit-protected banknotes have an IRPAT and a data matrix visible from either side of the banknote.

15. A method for verifying one or more counterfeit-protected banknotes printed on a banknote paper source having multiple inclusions of irreproducible-patterns (IRPAT), comprising:
inserting a subject banknote into a checking device,
determining whether the subject banknote has inclusions embedded in the irreproducible pattern (IRPAT) banknote paper,
reading a data matrix and denomination of the subject banknote and extracting a message from the read data matrix in relation to at least one digital signature security technique, and determining the authenticity of the subject banknote.

16. The method of claim 15, wherein the checking device scans the subject banknote for the IRPAT and the data matrix using a light source.

17. The method of claim 16, wherein the light source is ultra-violet (UV) light.

18. The method of claim 15, wherein the at least one digital signature security technique includes RSA, DSA, and CFS.

19. An authentic counterfeit-protected banknote having one or more irreproducible patterns (IRPAT) and one or more digital patterns, geometrically associated with one another and printed on a banknote paper source, wherein the banknote paper source has one or more synthetic inclusions, the digital patterns comprise one or more data matrixes associated with at least the denomination of the banknote, and the combination of the IRPAT and digital patterns are detectable by a checking device.

20. The banknote of claim 19, wherein the data matrix and IRPAT are physically present on the banknote.
